(19) United States
(12) Patent Application Publication
(10) Pub. No.: US 2007/0269712 A1
(43) Pub. Date: Nov. 22, 2007

(54) CLIPPING MECHANISM AND ELECTRONIC APPARATUS USING THE SAME

(75) Inventor: U-lin Ju, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/749,765

(22) Filed: May 17, 2007

(30) Foreign Application Priority Data
May 18, 2006 (TW) 95117723

(51) Int. Cl. H01M 2/10; A47G 1/10; B65D 45/16

(52) U.S. Cl. 429/97; 248/316.7; 220/324

(57) ABSTRACT

A clipping mechanism and electronic apparatus are provided. The clipping mechanism for clipping an object comprises a casing and a sliding device. The casing has a socket for containing the object. The sliding device disposed on the casing, has a clipping bump and sliding between a first position and a second position along a first direction. When the sliding device slides to the second position, the sliding device selectively moves forward and backward to the object along a second direction. When the sliding device slides between the first position and the second position, the clipping bump limits the object to be clipped with the socket. When the sliding device is located at the second position and slides away from the object toward a third position along the second direction, the clipping bump is separated from the object such that the object can be removed from the socket.

This application claims the benefit of Taiwan application Serial No. 095117723, filed May 18, 2006, the subject matter of which is incorporated herein by reference.

### BACKGROUND OF THE INVENTION

1. Field of the Invention

The invention relates in general to a clipping mechanism and electronic apparatus using the same, and more particularly to a clipping mechanism, which achieves the purpose of clipping or removing objects by using a sliding device and has a security mechanism of preventing objects from dropping, and electronic apparatus using the same.

2. Description of the Related Art

A portable electronic apparatus, such as a personal digital assistant (PDA), smart phone, digital camera or an electronic dictionary, has developed very rapidly and is very convenient for the user to receive information, process data or catch images whenever and wherever he/she needs due to the features of being thin, small and portable.

Generally speaking, the conventional portable electronic apparatus includes at least a battery and a clipping mechanism. The clipping mechanism includes a casing and a clipping button, and the battery is clipped in the casing by the clipping button.

However, when the user carries the portable electronic apparatus, there usually comes out an issue of clipping button loosening due to shack or collision. Therefore, in order to prevent clipping button from loosening, the conventional clipping mechanism uses a safety lock to lock up the clipping button. After the user uses the clipping button to clip the battery, he/she has to lock up the clipping button by the safety lock to ensure the battery will not loosen. However, the conventional clipping mechanism and the electronic apparatus using the same still have the following problems difficult to solve:

1. The operation is too complicated: when the user wants to clip the battery, he/she has to clip the battery by the clipping button first and then lock the clipping button by the safety lock. Conversely, when the user wants to take out the battery, he/she has to remove the safety lock to unlock the clipping button. The whole operation is too complicated for the user to perform by a signal hand, which leads to great inconvenience.

2. The occupied space is too large: the clipping mechanism including a clipping button and a safety lock occupies a large space of the electronic apparatus. Therefore, the electronic apparatus cannot have a smaller volume, which disobeys the trend of being “light, thin, short and small”.

3. The manufacturing cost is too high: the clipping button and safety lock both have to be made by a mold and fabricated individually. Therefore, not only the cost for components but also the time for fabrication is increased.

Therefore, in research and development of the portable electronic apparatus, how to conquer the above difficulties is indeed an essential subject today.

### SUMMARY OF THE INVENTION

The invention is directed to a clipping mechanism and electronic apparatus using the same. By using a sliding device to slide along a first direction and a second direction, the clipping mechanism provides the electronic apparatus with the function of clipping or removing an object and a security mechanism of preventing the object from dropping out. The electronic apparatus can have the advantages of simple operation, small occupying space and low manufacturing cost.

According to an aspect of the present invention, a clipping mechanism is provided. The clipping mechanism for clipping an object comprises a casing and a sliding device. The casing has a socket for containing the object. The sliding device, disposed on the casing, has a clipping bump and sliding between a first position and a second position along a first direction. When the sliding device slides to the second position, the sliding device can move forward or backward to the object along a second direction. When the sliding device slides between the first position and the second position, the clipping bump limits the object to clip with the socket. When the sliding device is located at the second position and slides away from the object toward a third position along the second direction, the clipping bump is separated from the object such that the object can be removed from the socket.

According to another aspect of the present invention, an electronic apparatus is provided. The electronic apparatus comprises a battery, a casing and a sliding device. The casing has a socket for containing the battery. The sliding device is disposed on the casing for sliding between a first position and a second position along a first direction. When the sliding device slides to the second position, the sliding device moves forward or backward to the battery. The sliding device has a clipping bump. When the sliding device slides between the first position and the second position, the clipping bump limits the battery to move out the socket. When the sliding device is located at the second position and moves away from the battery to a third position along the second direction, the clipping bump is separated from the battery such that the battery can be removed out from the socket.

The invention will become apparent from the following detailed description of the preferred but non-limiting embodiments. The following description is made with reference to the accompanying drawings.

### BRIEF DESCRIPTION OF THE DRAWINGS

FIG. 1 is an exploded schematic diagram of a clipping mechanism according to a first embodiment of the invention.

FIG. 2A is a schematic diagram of a sliding device of FIG. 1 located at a first position.

FIG. 2B is a schematic diagram of the sliding device of FIG. 2A located at the second position.

FIG. 2C is a schematic diagram of the sliding device of FIG. 2B located at a third position.

FIG. 3A is a top view of a part of the casing denoted by a dotted line 3A in FIG. 1.

FIG. 3B is a schematic structure diagram of the sliding device.

FIG. 4A is a rear view of the clipping mechanism of FIG. 2A.

FIG. 4B is a rear view of the clipping mechanism of FIG. 2B.

FIG. 4C is a rear view of the clipping mechanism of FIG. 2C.

FIG. 5 is a rear view of a clipping mechanism according to a second embodiment of the invention.

FIG. 6 is a body view of a sliding device in FIG. 5.

### DETAILED DESCRIPTION OF THE INVENTION

### Embodiment One

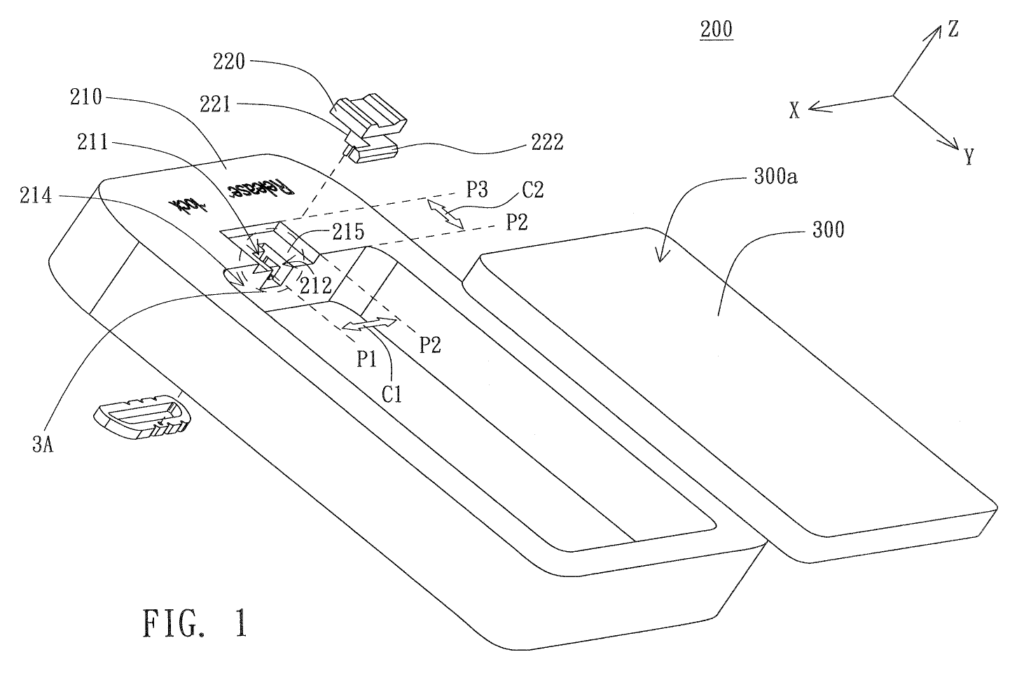

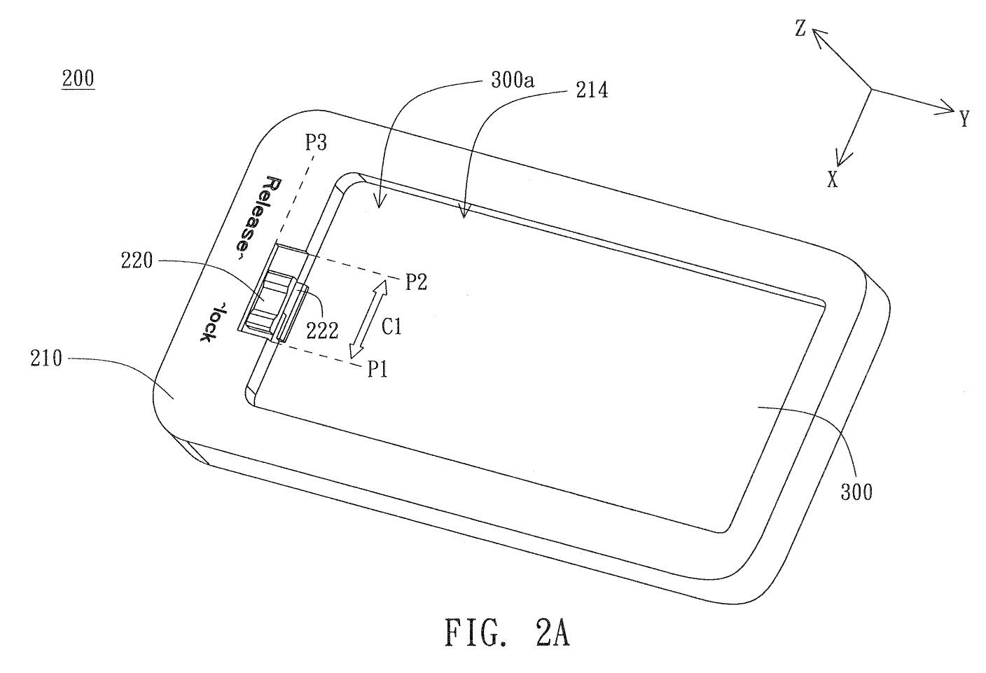

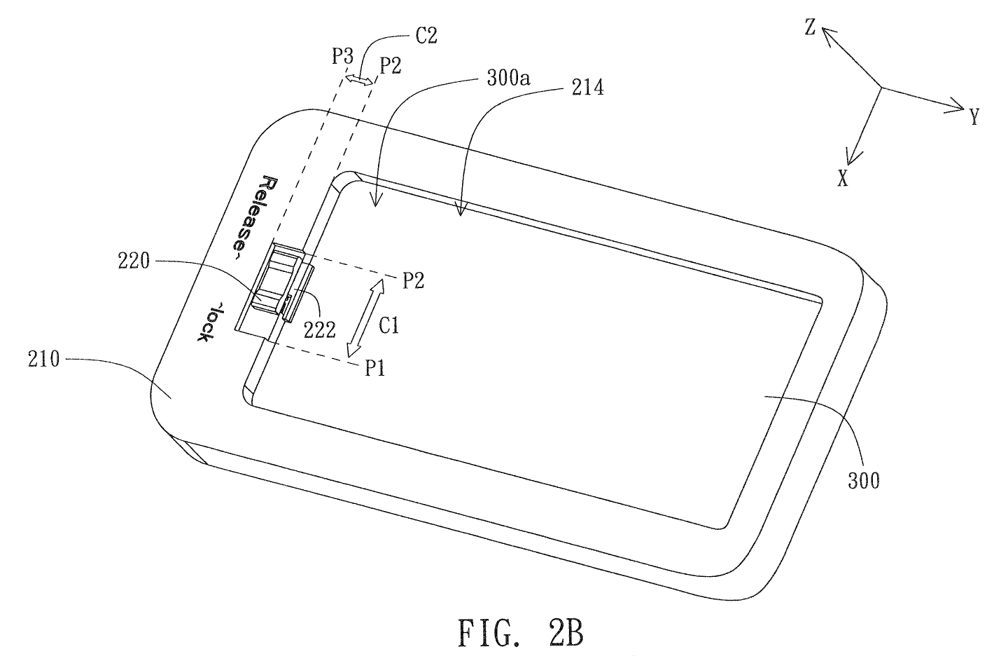

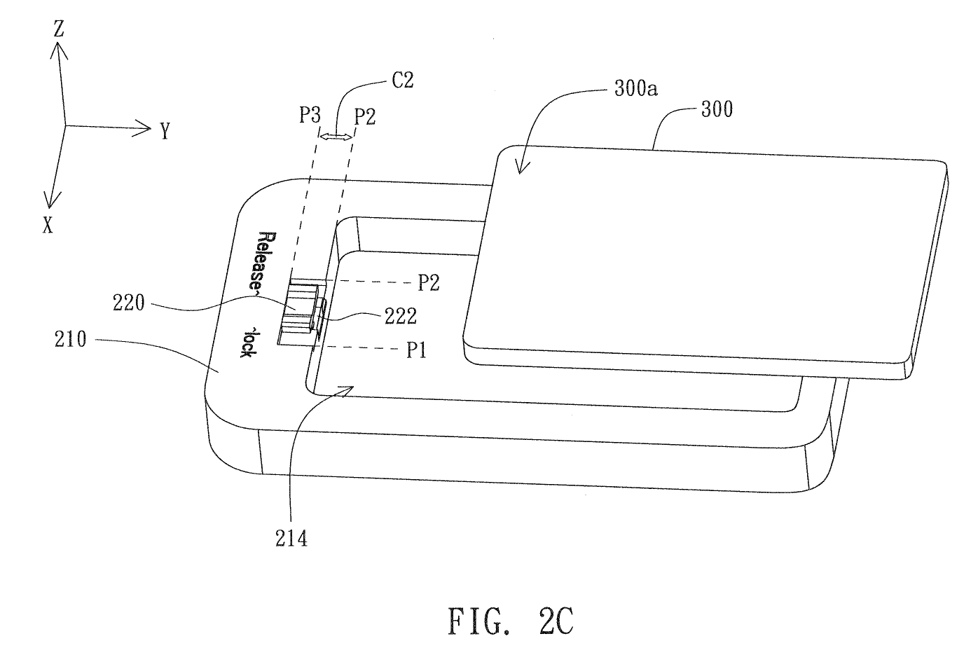

FIG. 1 is an exploded schematic diagram of a clipping mechanism 200 according to a first embodiment of the invention. FIG. 2A is a schematic diagram of a sliding device 220 of FIG. 1 located at a first position P1. Referring to FIG. 1 and FIG. 2A at the same time, a clipping mechanism 200 used for clipping an object 300 includes a casing 210 and a sliding device 220. The casing 210 has a socket 214 for containing the object 300. The sliding device 220 is disposed on the casing 210 and slides between the first position P1 and a second position P2 along a first direction C1 (the X-direction shown in the figure). When the sliding device 220 slides to the second position P2, the sliding device 220 selectively moves forward and backward to the object 300 along a second direction C2 (the Y-direction shown in the figure).

In the embodiment, the object 300 is a battery, and the casing 210 is a rear casing of a portable electronic apparatus. For example, the portable electronic apparatus is a PDA, smart phone, digital camera or an electronic dictionary.

FIG. 2B is a schematic diagram of the sliding device 220 of FIG. 2A located at the second position P2. Referring to FIG. 2A and FIG. 2B at the same time, the sliding device 220 has a clipping bump 222. When the sliding device 220 slides between the first position P1 and the second position P2, the clipping bump 222 limits the object 300 to be clipped with the socket 214.

FIG. 2C is a schematic diagram of the sliding device 220 of FIG. 2B located at a third position P3. Referring to FIG. 2B and FIG. 2C at the same time, when the sliding device 220 is located at the second position P2 and moves away from the object 300 to the third position P3 along the second direction C2, the clipping bump 222 is separated from the object 300 such that the object 300 can be removed from the socket 214.

In the embodiment, the sliding device 220 is disposed against an upper surface 300a of the object 300 through the clipping bump 222. Preferably, the bottom of the clipping bump 222 is attached to the upper surface 300a of the object 300 such that the clipping bump 222 can smoothly slide on the upper surface 300a of the object 300 along the first direction C1 or the second direction C2. When the sliding device 220 slides between the first position P1 and the second position P2, the clipping bump 222 protrudes out of the side wall of the socket 214 to go against the upper surface 300a of the object 300 and clip the object 300 with the socket 214 as shown in FIG. 2A and FIG. 2B. When the sliding device 300 moves from the second position P2 to the third position P3, the clipping bump 222 goes back into the side wall of the socket 214 to be separated from the upper surface 300a of the object 300 such that the object 300 can be removed from the socket 214 as shown in FIG. 2C.

As mentioned above, the clipping mechanism 200 has both the functions of clipping/removing the object 300 and preventing the object 300 from dropping out. When the sliding device 220 slides between the second position P2 and the third position P3 along the second direction C2, the clipping mechanism 200 has the function of clipping/removing the object 300. When the sliding device 220 slides between the second position P2 and the first position P1 along the first direction C1, the clipping mechanism 200 has the security mechanism of preventing the object 300 from dropping out. In details, when the sliding device 220 is located at the first position P1, the bump 222 cannot move along the second direction C2, and thus the object 300 can be restrained in the socket 214 without dropping.

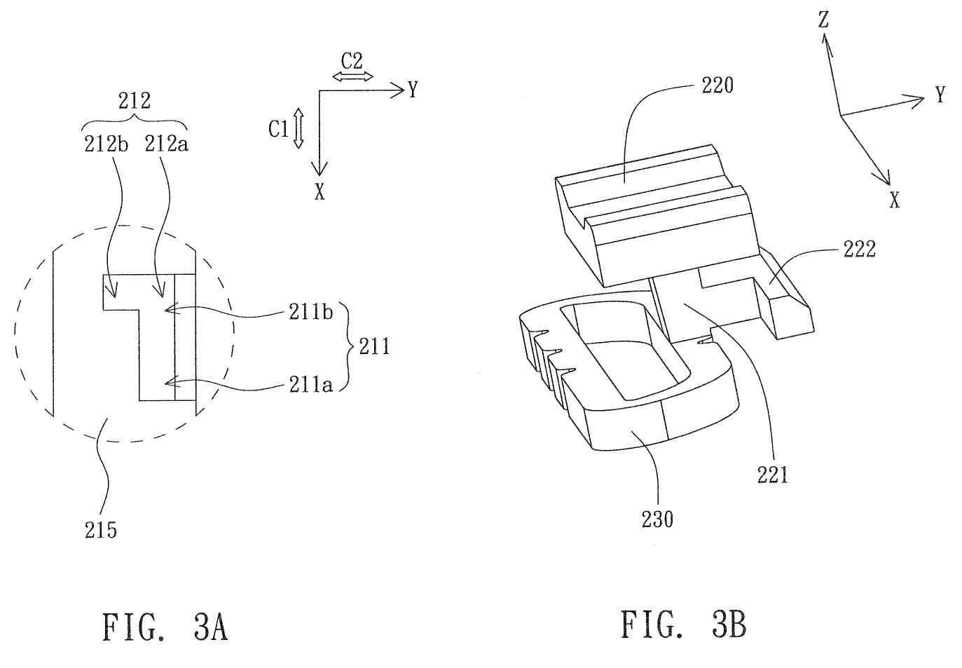

FIG. 3A is a top view of a part of the casing 210 denoted by a dotted line 3A in FIG. 1. Referring to FIG. 1 and FIG. 3A, the casing 210 further has a first guiding groove 211 and a second guiding groove 212. The first guiding groove 211 communicates with the second guiding groove 212. The first guiding groove 211 is parallel with the first direction C1 and the second guiding groove 212 is parallel with the second direction C2.

FIG. 3B is a schematic structure diagram of the sliding device 220. As shown in FIG. 3A and FIG. 3B, the siding device 220 includes a guiding bar 221. The guiding bar 221 moves in the first guiding groove 211 or the second guiding groove 212 to limit the sliding device 220 to move along the first direction C1 or the second direction C2.

The first guiding groove 211 has a first end 211a and a second end 211b. The second guiding groove 212 has a third end 212a and a fourth end 212b. The second end 211b of the first guiding groove 211 communicates with the third end 212a of the second guiding groove 212.

When the guiding bar 221 is located at the first end 211a, the sliding device 220 is located at the first position P1. Subsequently, when the guiding bar 221 slides to the second end 211b, the sliding device 220 is located at the second position P2 in the meanwhile the guiding bar 221 is located at the third end 212a. Afterward, when the guiding bar 221 slides to the fourth end 212b, the sliding device is located at the third position P3.

Conversely, the guiding bar 211 can slide from the fourth end 212b to the first end 211a through the third end 212a and the second end 211b such that the sliding device 220 moves from the third position P3 to the first position P1 through the second position P2.

The combination design of the guiding bar 211 and the first guiding groove 211 can maintain the clipping bump 222 to be positioned on the upper surface 300a of the object 300 to achieve the security mechanism of preventing the object 300 from dropping out.

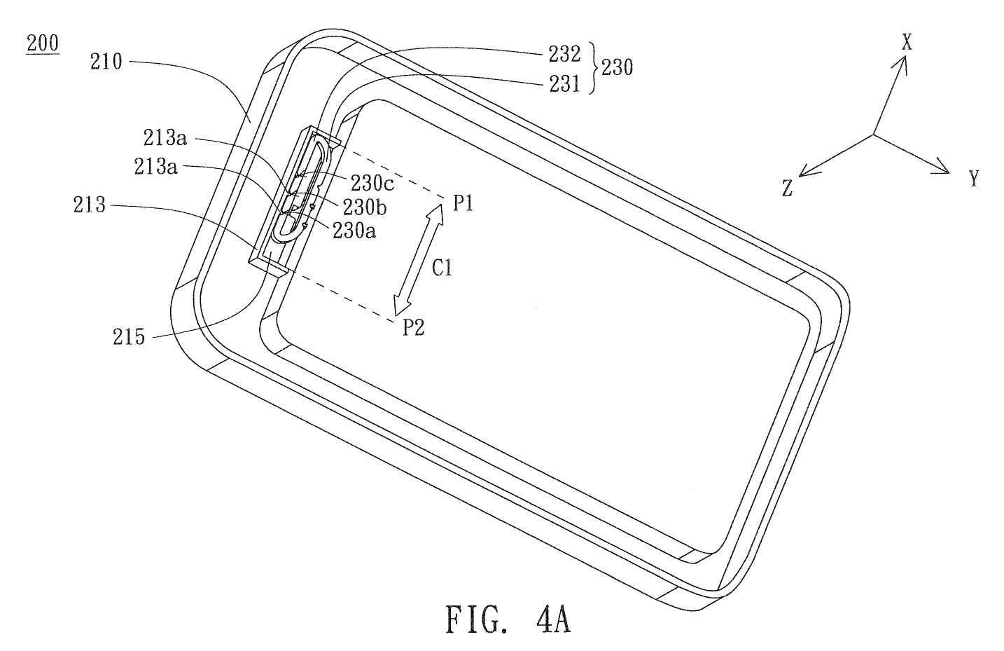

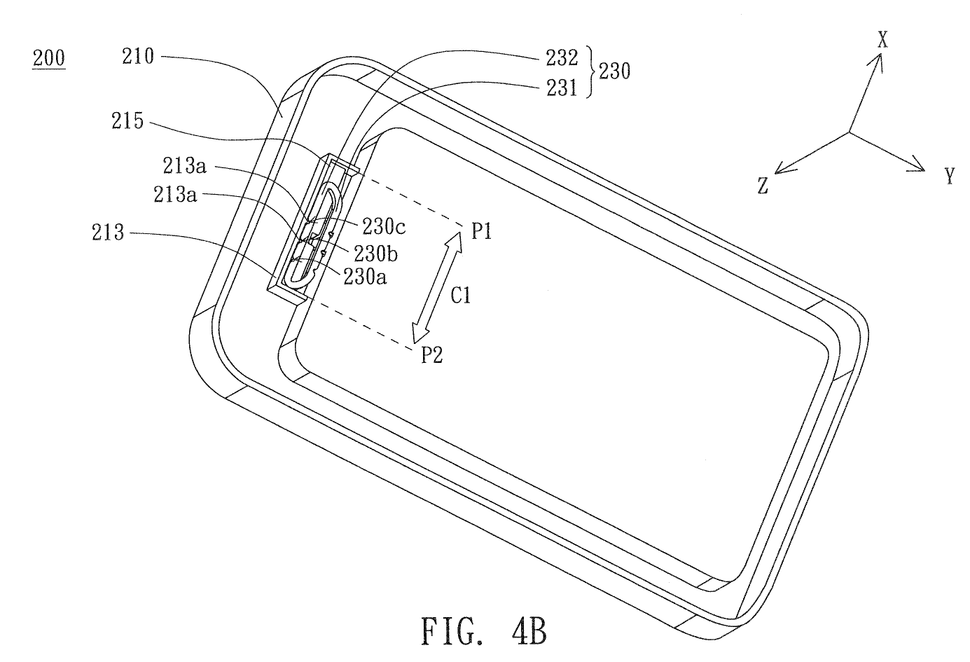

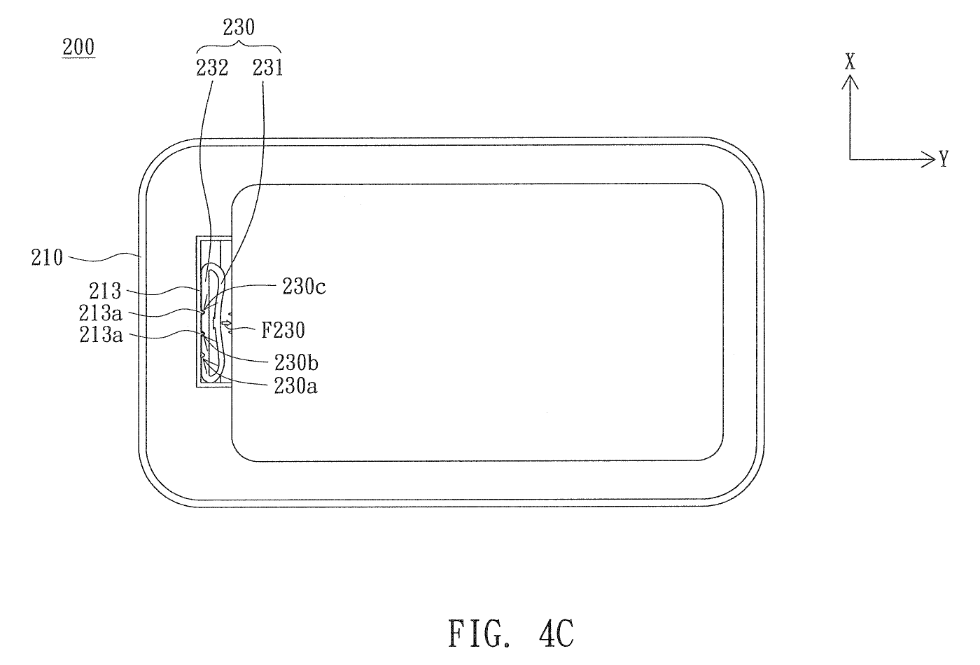

Referring to FIG. 4A, a rear view of the clipping mechanism 200 of FIG. 2A is shown. The casing 210 further includes a contact wall 213 and the clipping mechanism 200 further comprises an elastic device 230. The elastic device 230 is disposed between the sliding device 220 and the contact wall 213.

As shown in FIG. 3B, in the embodiment, the elastic device 230 is connected to the sliding device 220, and thus the sliding device 220 as sliding can bring the elastic device 230 to slide together.

As shown in FIG. 1, the casing 210 further includes a separation plate 215. The first guiding groove 211 and the second guiding groove 212 penetrate the separation plate 215. The guiding bar 221 penetrates the first guiding groove 211 and the second guiding groove 212 through one side of the separation plate 215. The elastic device 230 is connected to the guiding bar 221 at the other side of the separation plate 215. In this way, the sliding device 220 and the elastic device 230 can clip the separation plate 215 and respectively slide at two sides of the separation plate 215.

Preferably, the contact wall 213 and the elastic device 230 have corresponding concave or convex surfaces for positioning the sliding device 220 to the first position P1 or the second position P2. The concave or convex surfaces can be implemented in various ways, and the scope of the invention is not limited by the embodiment. The embodiment gives the structure of the contact wall 213 and the elastic device 230 shown in FIG. 3A and FIG. 3B as an example for illustration.

As shown in FIG. 4A, the contact wall 213 has two ribs 230a. The elastic device 230 has a first indent 230a, a second indent 230b and a third indent 230c. The distance between two ribs 230a is substantially equal to the distance between each two of the first indent 230a, the second indent 230b and the third indent 230c. Such that the ribs 230a is locked between adjacent two of the first indent 230a, the second indent 230b or the third indent 230c.

When the sliding device 220 slides along the first direction C1 to clip the ribs 213a with the first indent 230a and the second indent 230b, the sliding device 220 is positioned at the first position P1. By doing this, the sliding device 220, after positioned at the position P1, will not slide easily.

FIG. 4B is a rear view of the clipping mechanism 200 of FIG. 2B. Referring to FIG. 4A and FIG. 4B at the same time, when the sliding device 220 slides along the first direction C1 to clip the ribs 213a with the second indent 230b and the third indent 230c, the sliding device 220 is positioned at the second position P2. By doing this, the sliding device 220, after positioned at the second position P2, will not slide easily.

FIG. 4C is a rear view of the clipping mechanism 200 of FIG. 2C. Referring to FIG. 4B and FIG. 4C at the same time, when the sliding device 220 moves from the second position P2 to the third position P3 to press the elastic device 230 along the second direction C2, the elastic device 230 applies an elastic force F230 to the sliding device 220 to push the sliding device 220 back to the second position P2. The elastic device 230 of the invention can be implemented by various ways and is not limited by the embodiment. The elastic device 230 of the embodiment is exemplified to have the structure as in FIG. 4C.

In the embodiment, as shown in FIG. 4C, the elastic device 230 includes a first side wall 231 and a second side wall 232. The first side wall 231 is close to the sliding device 220 and the second side wall 232 is close to the contact wall 213. The first side wall 231 and the second side wall 232 form a ring-like structure. When the first side wall 231 is pressed to move elastically relative to the second side wall 232, the first side wall 231 generates an elastic force F230.

The above elastic device 230, sliding device 220 and contact wall 213 have the similar reverse operation relationship as the above. Any detail will not necessary to be given here.

### Embodiment Two

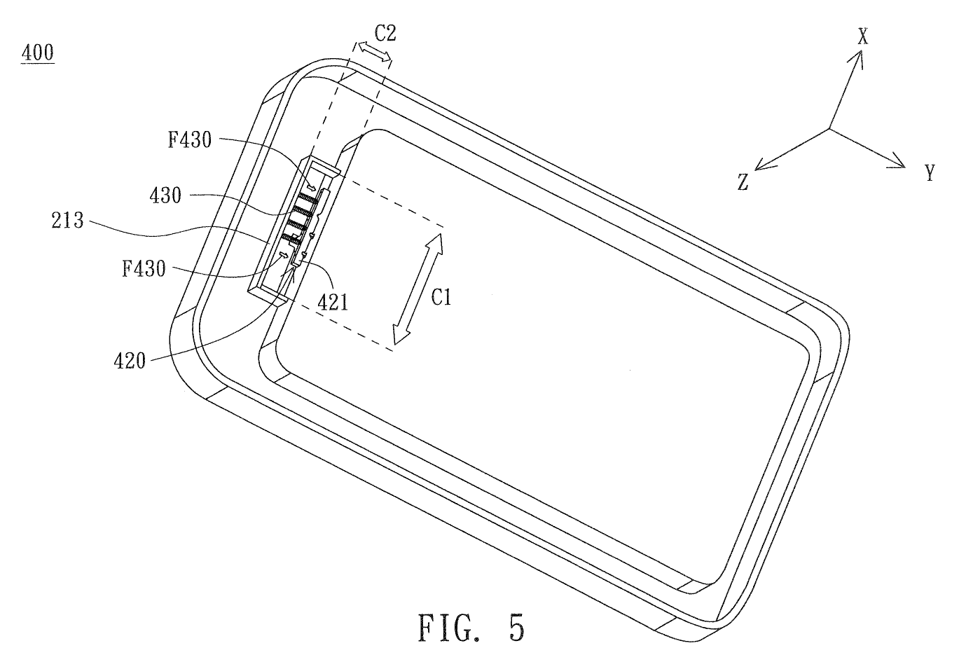

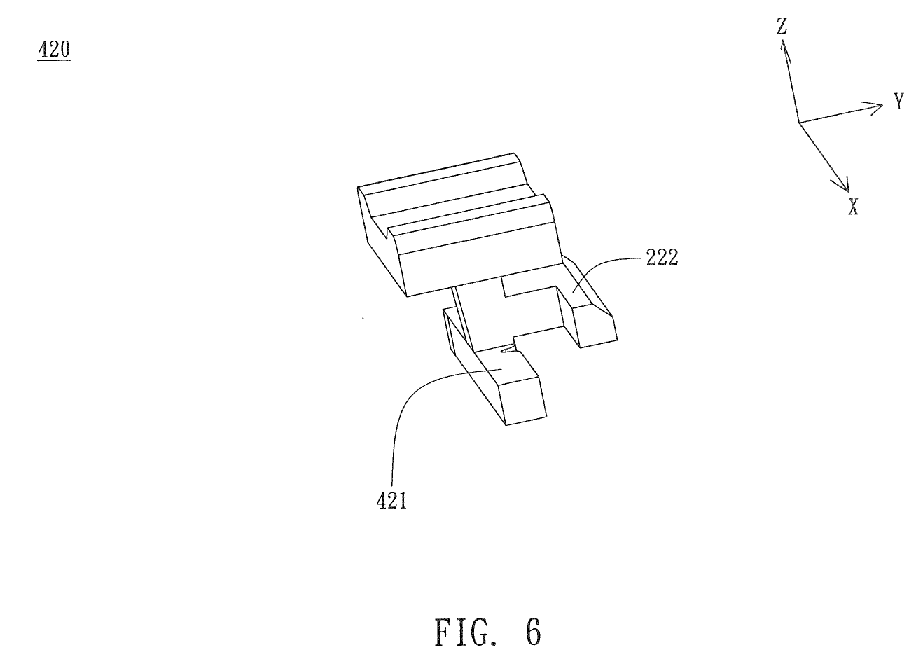

FIG. 5 is a rear view of a clipping mechanism 400 according to a second embodiment of the invention. FIG. 6 is a body view of a sliding device 420 in FIG. 5. Referring to FIG. 5 and FIG. 6 at the same time, the difference of the clipping mechanism 400 of the embodiment from the clipping mechanism 200 of the first embodiment lies in the sliding device 420 and the elastic device 430. Therefore, any details of the other similar components will not repeat here.

As shown in FIG. 5, in the embodiment, the elastic device 430 is a spring and the elastic device 430 is separated from the sliding device 420. The sliding device 420 has a positioning plate 421. The elastic device 430 has one end disposed against the positioning plate 421 and the other end disposed against the contact wall 213.

When the sliding device 420 slides along the first direction C1, the elastic device 430 is not brought to move together. The sliding device 420 brings only the positioning plate 421 to move together. However, in the sliding process of the sliding device 420, the elastic device 430 goes tightly against the positioning plate 421.

Besides, when the sliding device 420 slides along the second direction C2, the positioning plate 421 presses the elastic device 430, in the meanwhile the elastic device 430 applies an elastic force F430 to the sliding device 420 to push the sliding device 420 back to the original position.

According to the above two embodiments, although the elastic device is exemplified to be a ring-like structure and a spring, the elastic device of the invention can also be a twisting spring or a spring plate. As long as an elastic device can be used to supply an elastic force to the sliding device to achieve the purpose of moving the sliding device from the third position back to the second position, any alternative will not depart from the scope of the invention.

The clipping mechanism and electronic apparatus using the same disclosed by the above embodiment of the invention can achieve the purpose of clipping objects and safety security of preventing the objects from dropping by using a sliding device to move along a first direction and a second direction. By doing this, the clipping mechanism and electronic apparatus of the invention has the following effects:

1. The operation is simple: when the user is to clip the battery, he/she needs only to hold its casing by hand and push the sliding device by fingers of the same hand. The sliding device can be moved among the first position, the second position and the third position to achieve the purpose of clipping and removing the battery and the security mechanism of preventing the battery from dropping. Therefore, the clipping mechanism of the invention provides the user with great convenience.

2. The occupied space is small: the original casing of the electronic apparatus is combined with the sliding device to form the clipping mechanism of the invention and the elastic device is disposed under the separation plate. By doing this, the clipping mechanism will not occupy too much space of the electronic apparatus and thus the electronic apparatus can have a smaller volume to achieve the trend of being “light, thin, short and small”.

3. The manufacturing cost is low: the clipping mechanism can be fabricated by using only a sliding device. Compared to the prior-art clipping mechanism using a clipping button and safety lock, the clipping mechanism of the invention can not only have a lower cost for components but also reduce the fabrication time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A clipping mechanism, for clipping an object, comprising:
a casing, having a socket for containing the object; and
a sliding device, having a clipping bump, the sliding device disposed on the casing and sliding between a first position and a second position along a first direction, wherein when the sliding device slides to the second position, the sliding device selectively moves forward and backward to the object along a second direction;
wherein when the sliding device slides between the first position and the second position, the clipping bump limits the object to be clipped with the socket;
when the sliding device is located at the second position and slides away from the object toward a third position along the second direction, the clipping bump is separated from the object such that the object can be removed from the socket.

2. The clipping mechanism according to claim 1, wherein the casing has a first guiding groove and a second guiding groove, the first guiding groove communicates with the second guiding groove, the first guiding groove is in parallel with the first direction, the second guiding groove is in parallel with the second direction, the sliding device further comprises:
a guiding bar, moving in the first guiding groove or the second guiding groove for limiting the sliding device to move along the first direction or the second direction.

3. The clipping mechanism according to claim 1, wherein the casing has a contact wall, the clipping mechanism further comprises:
an elastic device, disposed between the sliding device and the contact wall;
wherein when the sliding device moves from the second position to the third position along the second direction to press the elastic device, the elastic device applies an elastic force to the sliding device such that the sliding device can move back to the second position.

4. The clipping mechanism according to claim 3, wherein the contact wall and the elastic device have corresponding concave or convex surfaces for positioning the sliding device at the first position or the second position.

5. The clipping mechanism according to claim 4, wherein the contact wall has two ribs, the elastic device has a first indent, a second indent and a third indent;
wherein when the sliding device slides along the first direction to clip the ribs with the first indent and the second indent, the sliding device is positioned at the first position;
when the sliding device slides along the first direction to clip the ribs with the second indent and the third indent, the sliding device is positioned at the second position.

6. The clipping mechanism according to claim 3, wherein the elastic device is connected to the sliding device.

7. The clipping mechanism according to claim 6, wherein the casing comprises:
a separation plate, the first guiding groove and the second guiding groove penetrating the separation plate, the guiding bar penetrating the first guiding groove and the second guiding groove through one side of the separation plate, the elastic device being connected to the guiding bar at the other side of the separation plate.

8. The clipping mechanism according to claim 3, wherein the elastic device comprises:
a first side wall, located close to the sliding device; and
a second side wall, located close to the contact wall, wherein the first side wall and the second side wall form a ring-like structure, when the first side wall is pressed to move elastically relative to the second side wall, the first side wall generates the elastic force.

9. The clipping mechanism according to claim 3, wherein the elastic device is a spring, a spring plate or a twisting spring.

10. The clipping mechanism according to claim 1, wherein the object is a battery.

11. An electronic apparatus, comprising:
a battery;
a casing, having a socket for containing the battery; and
a sliding device, disposed on the casing and sliding between a first position and a second position along a first direction, wherein when the sliding device slides to the second position, the sliding device selectively moves forward and backward to the battery, the sliding device has a clipping bump, when the sliding device slides between the first position and the second position, the clipping bump limits the battery to be clipped with the socket, when the sliding device is located at the second position and moves away from the battery to a third position along the second direction, the clipping bump is separated from the battery such that the battery can be removed from the socket.

12. The electronic apparatus according to claim 11, wherein the casing has a first guiding groove and a second guiding groove, the first guiding groove communicates with the second guiding groove, the first guiding groove is in parallel with the first direction, the second guiding groove is in parallel with the second direction, the sliding device further comprises:
a guiding bar, moving in the first guiding groove or the second guiding groove for limiting the sliding device to move along the first direction or the second direction.

13. The electronic apparatus according to claim 11, wherein the casing has a contact wall, the electronic apparatus further comprises:
an elastic device, disposed between the sliding device and the contact wall;
wherein when the sliding device moves from the second position to the third position along the second direction to press the elastic device, the elastic device applies an elastic force to the sliding device such that the sliding device can move back to the second position.

14. The electronic apparatus according to claim 13, wherein the contact wall and the elastic device have corresponding concave or convex surfaces for positioning the sliding device at the first position or the second position.

15. The electronic apparatus according to claim 13, wherein the contact wall has two ribs, the elastic device has a first indent, a second indent and a third indent;
wherein when the sliding device slides along the first direction to clip the ribs with the first indent and the second indent, the sliding device is positioned at the first position;
when the sliding device slides along the first direction to clip the ribs with the second indent and the third indent, the sliding device is positioned at the second position.

16. The electronic apparatus according to claim 13, wherein the elastic device is connected to the sliding device.

17. The electronic apparatus according to claim 16, wherein the casing comprises:
a separation plate, the first guiding groove and the second guiding groove penetrating the separation plate, the guiding bar penetrating the first guiding groove and the second guiding groove through one side of the separation plate, the elastic device being connected to the guiding bar through the other side of the separation plate.

18. The electronic apparatus according to claim 13, wherein the elastic device comprises:
a first side wall, located close to the sliding device; and
a second side wall, located close to the contact wall, wherein the first side wall and the second side wall form a ring-like structure, when the first side wall is pressed to move elastically relative to the second side wall, the first side wall generates the elastic force.

19. The electronic apparatus according to claim 13, wherein the elastic device is a spring, a spring plate or a twisting spring.
